(19) United States
(12) Patent Application Publication
(10) Pub. No.: US 2014/0186577 A1
(43) Pub. Date: Jul. 3, 2014

(54) BREATHABLE ELASTIC BUFFER MATERIAL STRUCTURE

(71) Applicant: Chang-Hsin WU, Taibao City (TW)

(72) Inventor: Chang-Hsin WU, Taibao City (TW)

(21) Appl. No.: 13/729,874

(22) Filed: Dec. 28, 2012

(51) Int. Cl. B32B 3/08; B32B 5/24

(52) U.S. Cl. CPC B32B 3/085; B32B 5/24
USPC 428/119

(57) ABSTRACT

A breathable elastic buffer material structure includes two breathable fabrics, a plurality of spaced elastic pillars between the two breathable fabrics and an elastic plate between the two breathable fabrics. The elastic plate has a plurality of spaced through holes and ribs between the through holes. The elastic pillars are inserted through the through holes, respectively. The ribs of the elastic plate are located between the elastic pillars. When the elastic pillars are applied with an impact force, the ribs not only provide an elastic buffer effect itself but also bear the impact force so the elastic pillars won't slant to enhance the buffer effect. In case a rod-like object penetrates between the elastic pillars, the ribs can block the rod-like object. The present invention provides better buffer and protection effects and is very practical.

### BACKGROUND OF THE INVENTION

1. Field of the Invention

The present invention relates to a breathable elastic buffer material structure, and more particularly, to a plate-shaped breathable elastic buffer material structure which can enhance its buffer effect and prevent a rod-shaped object from penetrating therethrough.

2. Description of the Prior Art

A plate-shaped breathable buffer material is used as the material of a shoe pad or protective clothes. As shown in FIG. 1, FIG. 2 and FIG. 3, a conventional structure comprises two breathable fabrics 1, 3 and a plurality of spaced elastic pillars 2 connected between the two breathable fabrics 1, 3. Between every two adjacent elastic pillars 2 has a gap H. This structure has the following shortcomings:
1. As shown in FIG. 3, when the elastic pillars 2 are applied with an impact force W, the elastic pillars 2 will be slanted by the impact force because of the gaps H between the elastic pillars 2. The impact force W will act on the human's body greatly. That is to say, the elastic pillars 2 are unable to provide a better buffer effect.
2. As shown in FIG. 3, when the elastic pillars 2 are applied with the impact force W, the elastic pillars 2 will be slanted. The elastic pillars 2 are adhered to the breathable fabrics 1, 3 so the elastic pillars 2 will pull the breathable fabrics 1, 3. In general, the breathable fabrics 1, 3 are non-woven fabric or gauze and have less endurance strength so the breathable fabrics 1, 3 are torn up with ease.

Accordingly, the present invention intends to provide a breathable elastic buffer material structure for improving the shortcomings mentioned above.

### SUMMARY OF THE INVENTION

The primary object of the present invention is to provide a breathable elastic buffer material structure which comprises two breathable fabrics, a plurality of spaced elastic pillars between the two breathable fabrics and an elastic plate between the two breathable fabrics. The elastic plate has a plurality of spaced through holes and ribs between the through holes. The elastic pillars are respectively inserted through the through holes. The ribs of the elastic plate are located between the elastic pillars. When the elastic pillars are applied with an impact force, the ribs can hold against the peripheries of the elastic pillars to prevent the elastic pillars from slanting. The ribs also have elasticity to enhance the buffer effect. In case a rod-like object penetrates between the elastic pillars, the ribs can block the rod-like object. The present invention provides a better protection effect.

### BRIEF DESCRIPTION OF THE DRAWINGS

FIG. 1 is an exploded view of the prior art;

FIG. 2 is a sectional view of the prior art;

FIG. 3 is a schematic view showing the prior art applied with an impact force.

FIG. 4 is an exploded view of the present invention;

FIG. 5 is a perspective partial sectional view of the present invention;

FIG. 6 is a top view of the present invention;

FIG. 7 is a sectional view of the present invention;

FIG. 8 is a sectional view of the present invention applied with an impact force; and

FIG. 9 is a perspective view of another embodiment of the present invention.

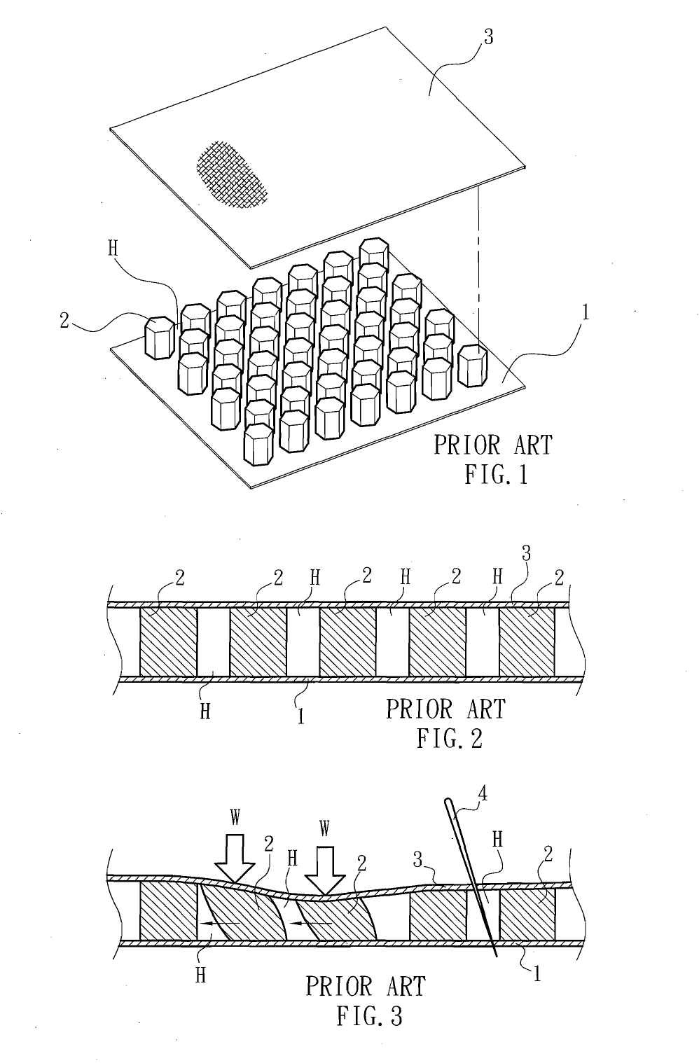

### DETAILED DESCRIPTION OF THE PREFERRED EMBODIMENTS

Embodiments of the present invention will now be described, by way of example only, with reference to the accompanying drawings.

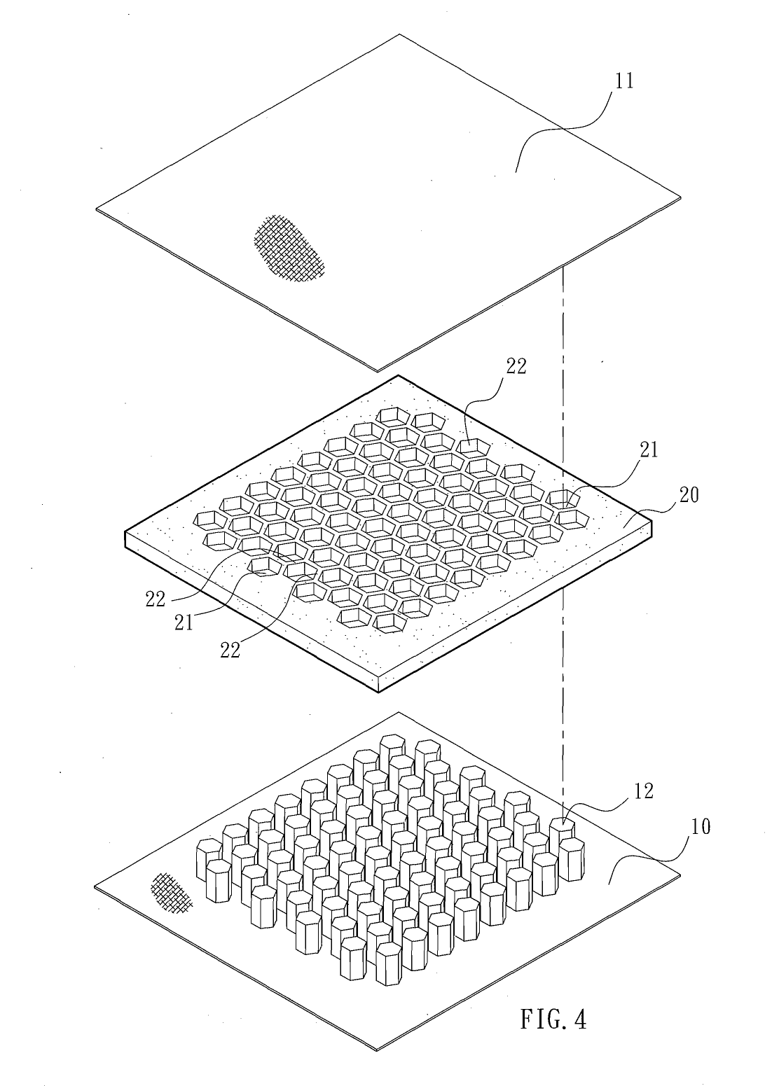

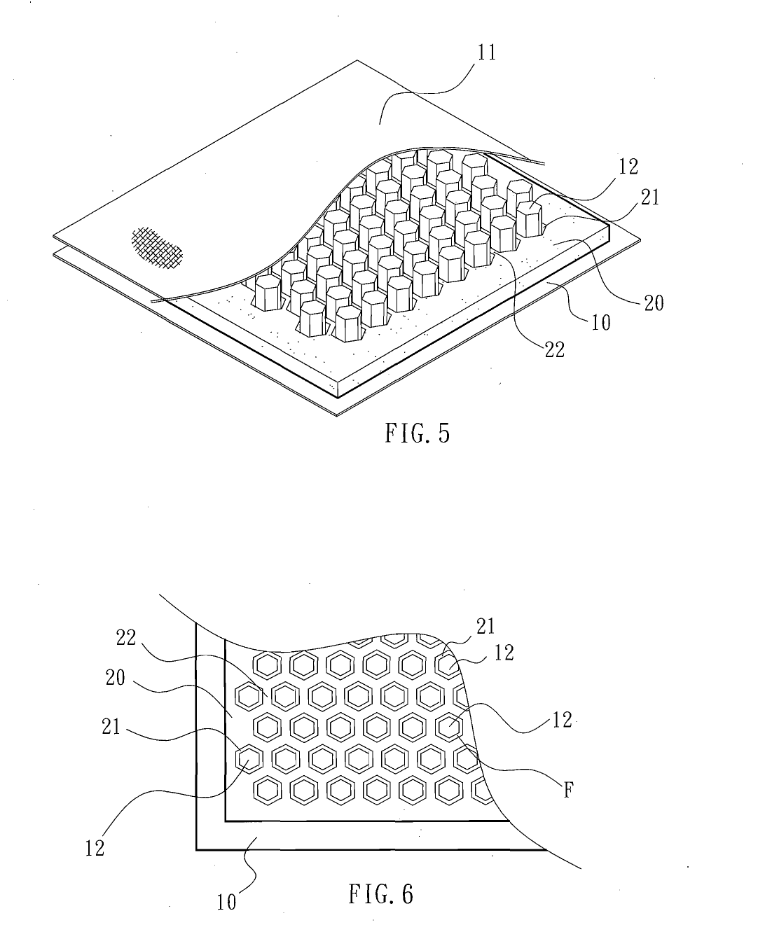

As shown in FIG. 4 to FIG. 8, the present invention comprises two breathable fabrics 10, 11, a plurality of spaced elastic pillars 12 between the two breathable fabrics 10, 11, and an elastic plate 20 between the two breathable fabrics 10, 11. The elastic plate 20 has a plurality of spaced through holes 21 and ribs 22 between the through holes 21. The elastic pillars 12 are respectively inserted through the through holes 21. The through holes 21 have a diameter slightly greater than that of the elastic pillars 12 so a gap F is defined between each rib 22 and the corresponding elastic pillar 12.

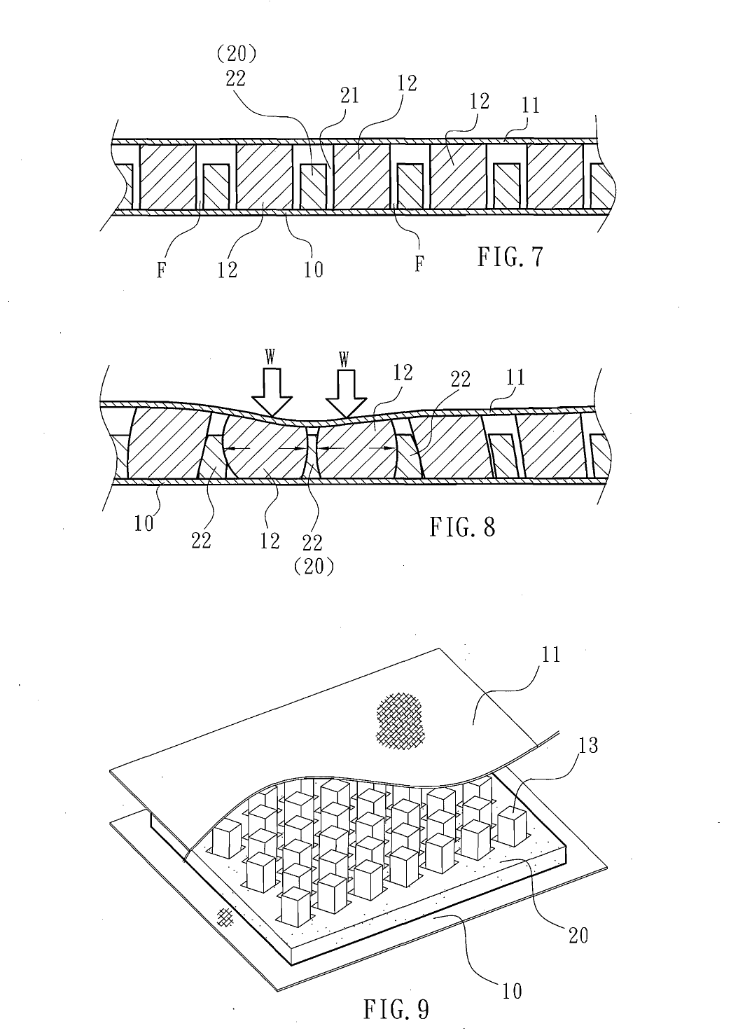

The present invention has the following effects and advantages:
1. As shown in FIG. 7 and FIG. 8, the gap F is defined between each elastic pillar 12 and the corresponding rib 22 of the elastic plate 20. When the elastic pillars 12 are compressed and deformed by an impact force W, the gap F provides a space for the elastic pillars 12 to be compressed and deformed. The ribs 22 also have elasticity, so that the ribs 22 are able to hold against the elastic pillars 22 respectively to prevent the elastic pillars 12 from slanting. The ribs 22 can bear the impact force W sent from the elastic pillars 12. That is to say, the elastic pillars 12 and the elastic ribs 22 are able to bear the impact force W to enhance the buffer effect. Furthermore, the elastic pillars 12, as shown in FIG. 8, don't slant and are in a vertical state, achieving a better buffer effect.
2. As shown in FIG. 8, the elastic pillars 12 are supported by the ribs 22 so they won't slant. Therefore, the breathable fabrics 10, 11 won't be pulled greatly to be torn up.
3. As shown in FIG. 8, the ribs 22 are disposed between the elastic pillars 12. In case a rod-like object penetrates between the elastic pillars 12, the ribs 22 can block the rod-like object to provide a protection effect.
4. As shown in FIG. 8, when the elastic pillars 12 are applied with an external force and the external force is continuous and periodic, the elastic pillars 12 will be compressed and deformed to expel (hot) air between the ribs 22 and the elastic pillars 12. When the elastic pillars 12 are restored, (cool) air will be inhaled. The circulation provides a better heat dissipation effect.

The elastic pillars 12 of the present invention can be square, triangle, round or other geometric shape, as shown in FIG. 9. The elastic plate 20 can be made of foam to decrease its weight.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A breathable elastic buffer material structure, comprising two breathable fabrics, a plurality of spaced elastic pillars between the two breathable fabrics and an elastic plate between the two breathable fabrics, the elastic plate having a plurality of spaced through holes and ribs between the through holes, the elastic pillars being respectively inserted through the through holes, the through holes having a diameter slightly greater than that of the elastic pillars so a gap F is defined between each rib 22 and the corresponding elastic pillar; wherein when the elastic pillars are compressed and deformed by an impact force, the gap provides a space for the elastic pillars to be compressed and deformed, and the ribs are able to support the elastic pillars respectively and bear the impact force sent from the elastic pillars.
